(19) United States
(12) Patent Application Publication
(10) Pub. No.: US 2018/0296305 A1
(43) Pub. Date: Oct. 18, 2018

(54) DENTAL PROSTHESIS AND METHOD FOR REMOVAL

(71) Applicant: Karin Henriette Dentzer, Aachen (DE)

(72) Inventor: Ralf Dentzer, Aachen (DE)

(21) Appl. No.: 15/916,869

(22) Filed: Mar. 9, 2018

Related U.S. Application Data
(63) Continuation of application No. PCT/EP2016/007006, filed on Aug. 24, 2016.

(30) Foreign Application Priority Data
Sep. 9, 2015 (DE) 102015115186.3

(51) Int. Cl. A61C 8/00; A61C 13/01; A61C 1/00

(52) U.S. Cl. CPC A61C 8/0089; A61C 8/0077; A61C 8/005; A61C 2204/002; A61C 13/04; A61C 1/0015; A61C 8/0081

(57) ABSTRACT

A dental prosthesis including a prosthesis base and at least one artificial tooth, and including at least one micro drive for detaching the dental prosthesis from an alveolar crest. The invention further relates to a method for removing such a dental prosthesis from an oral cavity, wherein the dental prosthesis is detached from an alveolar crest in the oral cavity by means of a micro drive and then manually removed from the oral cavity. In order to detach a dental prosthesis adhering to the alveolar crest, the micro drive according to the invention is a micro motor which drives a lifting means which lifts the dental prosthesis from the alveolar crest.

### RELATED APPLICATIONS

This application is a continuation of International Application PCT/EP2016/07006 filed on Aug. 24, 2016 claiming priority from German Patent Application DE 10 2015 115 186.3 filed on Sep. 9, 2015, both of which are incorporated in their entirety by this reference.

### FIELD OF THE INVENTION

The invention relates to a dental prosthesis. The invention also relates to a method for removing the dental prosthesis from an oral cavity.

### BACKGROUND OF THE INVENTION

In order to replace plural or all teeth dental prostheses (partial or total prostheses) are being used which are typically inserted in the morning and removed again from the oral cavity in the evening. Whereas it was difficult in former times to fix the dental prosthesis in the oral cavity today typically considerable force is required to disengage the fixing of the dental prosthesis.

DE 20 015 736 U1 and DE 10 2006 026 864 A1 propose to interlock a dental prosthesis at an implant and to disengage the interlocking with a micro drive by approaching a magnet from an outside or with an integrated electromagnet or micro motor.

KR10 2006 0064 836 A discloses a motor supported denture and U.S. Pat. No. 6,023,325 B1 discloses tooth implants with an intermediary layer that dampens a loading of the alveolar crest during chewing.

The solutions known in the art however do not facilitate disengaging a dental prosthesis that adheres to the alveolar crest.

### BRIEF SUMMARY OF THE INVENTION

Thus, it is an object of the invention to disengage a dental prosthesis that adheres to the alveolar crest.

Improving upon known dental prosthesis it is proposed according to the invention that the micro drive is a micro motor that drives a lifting device which lifts the dental prosthesis from the alveolar crest. The micro drive thus applies a force that exceeds an adhesion force of the dental prosthesis and generates a distance between the dental prosthesis and the alveolar crest so that the dental prosthesis can be removed from the oral cavity manually without much force.

The object is achieved by a dental prosthesis including a prosthesis base; at least one artificial tooth; and at least one micro drive configured to detach the dental prosthesis from an alveolar crest, wherein the at least one micro drive is a micro motor which drives a lifting device that lifts the dental prosthesis from the alveolar crest.

The object is also achieved by a method for removing a dental prosthesis including a prosthesis base and at least one artificial tooth from an oral cavity, the method including the steps detaching the dental prosthesis from an alveolar crest in the oral cavity by a micro drive; and manually removing the dental prosthesis from the oral cavity, wherein the micro drive is a micro motor that drives a lifting device that lifts the dental prosthesis from the alveolar crest,

Advantageously a dental prosthesis according to the invention includes at least one anchoring device for anchoring the dental prosthesis on an implant in the alveolar crest wherein the anchoring is disengaged by lifting the dental prosthesis by the lifting device from the implant. A dental prosthesis of this type is better protected against unintentional removal than a dental prosthesis that adheres exclusively through adhesion.

In particular the anchoring device of the dental prosthesis according to the invention can be a mechanical clamping element which envelops a ball head protruding from the implant like e.g. in DE 10 2006 026 864 A1.

Furthermore the anchoring device at the dental prosthesis according to the invention can be a permanent magnet, e.g. a neodymium magnet which adheres when approached to a ferro magnetic counter piece in the implant.

Advantageously the micro drive is integrated into a prosthesis base of a dental prosthesis according to the invention. Therefore the micro drive does not bother the bearer.

Advantageously the micro drive is cast into the prosthesis base of the dental prosthesis according to the invention. Thus, the connection between the micro drive and the dental prosthesis is particularly firm. In particular retaining elements can be attached at an outside of the micro drive which effectively prevent a disengagement from the prosthesis base.

Battery driven hydraulic and electromagnetic micro motors are commercially available in different sizes and power ratings as standard components and facilitate very precise positioning of the lifting device adapted to specific requirements.

Advantageously a voltage source for providing energy to the micro drive is integrated into a dental prosthesis according to the invention. Thus, the micro drive can be operated without an external voltage source.

Improving upon the known methods it is proposed according to the invention that the micro drive is a micro motor which drives a lifting device that lifts the dental prosthesis from the alveolar crest. The method according to the invention is performed with one of the dental prostheses according to the invention recited supra and is characterized by the advantages recited supra.

Advantageously the micro drive is triggered touch free according to the method according to the invention. The disengagement of the dental prosthesis from the alveolar crest can then be controlled remotely by an external device or operating element.

### BRIEF DESCRIPTION OF THE DRAWINGS

The invention is subsequently described in more detail based on an embodiment with reference to a drawing figure, wherein:

FIG. 1A illustrates a perspective view of a dental prosthesis according to the invention;

FIG. 1B illustrates a sectional view of the dental prosthesis according to the invention parallel to the alveolar crest;

FIG. 2A illustrates a sectional view of the dental prosthesis according to the invention transversal to the alveolar crest in a condition that is inserted into the oral cavity; and

FIG. 2B illustrates the dental prosthesis according to the invention lifted off from the alveolar crest and ready for removal from the oral cavity.

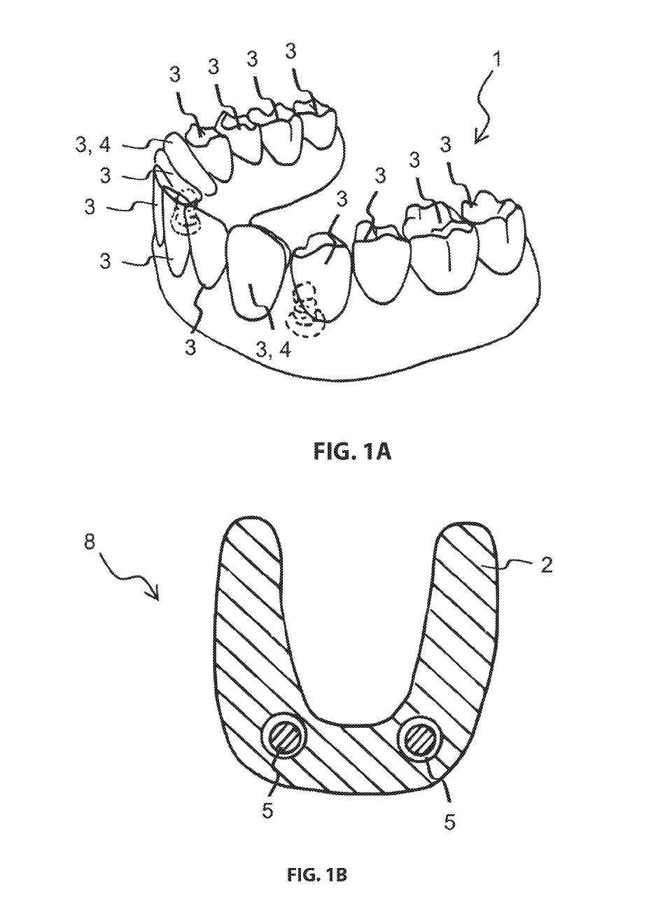

### DETAILED DESCRIPTION OF THE INVENTION

The dental prosthesis 1 according to the invention is a lower jaw total prosthesis for an adult and includes a prosthesis base 2 that is made from a plastic material and artificial teeth 3 made from zirconium oxide. Two micro drives 5 are cast into the prosthesis base 2 respectively at the level of the cuspids 4.

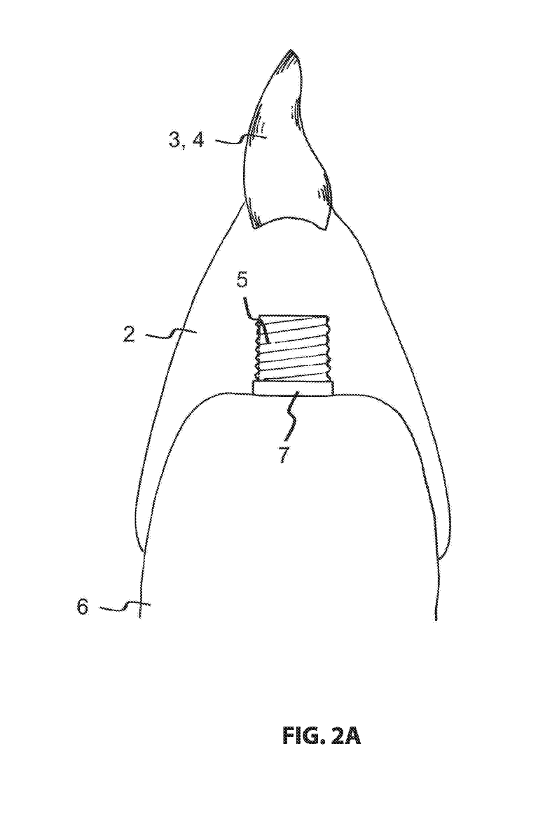

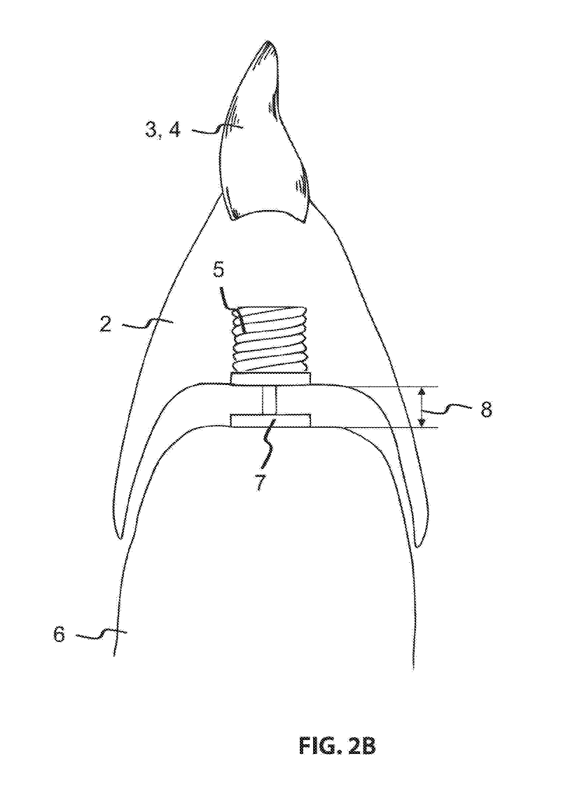

In the condition illustrated in FIG. 2A where the prosthesis is inserted into the non-illustrated oral cavity the prosthesis base 2 contacts the alveolar crest 6 or the alveolar crest tissue with a surface and is supported at the alveolar crest by adhesion. The prosthesis cannot be removed from the oral cavity without substantial force application. The lifting devices 7 of the micro drives 5 contact the surface of the prosthesis base 2 and the alveolar crest in a basic position.

In order to remove the dental prosthesis 1 a super capacitor that is integrated in the prosthesis base 2 is initially charged by a hand unit in a contact less manner. After a sufficient charge the lifting devices 7 are automatically extended by the micro drives 5 by a distance 8 of approximately 2 mm so that the dental prosthesis 1 as a whole lifts by the distance 8 from the alveolar crest 6.

FIG. 2B illustrates the dental prosthesis 1 after extending the lifting device 7. The dental prosthesis 1 can now be removed from the oral cavity without additional force application. The lifting devices 7 move back into the starting position self-acting upon discharging of the super capacitor.

In a second non-illustrated dental prosthesis according to the invention ferro magnetic plates are implanted into the surface of the alveolar crest tissue in the contact surfaces of the lifting devices which differs from the first dental prosthesis. The micro drives are provided with neodymium magnets which stabilize the second dental prosthesis on the alveolar crest in the condition where the prosthesis is inserted into the oral cavity. The lifting devices are made from a non ferro magnetic plastic material and increase the distance between the plates and the magnets in order to remove the second dental prosthesis. A third dental prosthesis according to the invention that is also not illustrated is a cover prosthesis or hybrid prosthesis which is supported on implants with ball heads which differs from the first dental prosthesis. The lifting devices facilitate lifting the third dental prosthesis from the ball heads.

### REFERENCE NUMERALS AND DESIGNATIONS

1 dental prosthesis

2 prosthesis base

3 tooth

4 cuspid

5 micro drive

6 alveolar crest

7 lifting device

8 distance

What is claimed is:

1. A dental prosthesis, comprising:
a prosthesis base;
at least one artificial tooth; and
at least one micro drive configured to detach the dental prosthesis from an alveolar crest,
wherein the at least one micro drive is a micro motor which drives a lifting device that lifts the dental prosthesis from the alveolar crest.

2. The dental prosthesis according to claim 1, further comprising:
at least one anchoring device configured to anchor the dental prosthesis on an implant in the alveolar crest,
wherein the dental prosthesis is disengaged from the implant by lifting the dental prosthesis from the implant by the lifting device.

3. The dental prosthesis according to claim 2, wherein the at least one anchoring device is a mechanical clamping element.

4. The dental prosthesis according to claim 2, wherein the at least one anchoring device is a permanent magnet.

5. The dental prosthesis according to claim 1, wherein the at least one micro drive is integrated into the prosthesis base of the dental prosthesis.

6. The dental prosthesis according to claim 5, wherein the at least one micro drive is cast into the prosthesis base

7. The dental prosthesis according to claim 1, wherein a voltage source that supplies energy to the at least one micro drive is integrated into the dental prosthesis.

8. A method for removing a dental prosthesis including a prosthesis base and at least one artificial tooth from an oral cavity, the method comprising the steps:
detaching the dental prosthesis from an alveolar crest in the oral cavity by a micro drive; and
manually removing the dental prosthesis from the oral cavity,
wherein the micro drive is a micro motor that drives a lifting device that lifts the dental prosthesis from the alveolar crest.

9. The method according to claim 8, wherein the micro drive is triggered contactless.
